(19) United States
(12) Patent Application Publication
(10) Pub. No.: US 2013/0082549 A1
(43) Pub. Date: Apr. 4, 2013

(54) SWITCHED RELUCTANCE MOTOR

(71) Applicants: Moon Kyu Han, Gyunggi-do (KR); Han Kyung Bae, Gyunggi-do (KR); Dong Woohn Kim, Gyunggi-do (KR)

(72) Inventors: Moon Kyu Han, Gyunggi-do (KR); Han Kyung Bae, Gyunggi-do (KR); Dong Woohn Kim, Gyunggi-do (KR)

(73) Assignee: Samsung Electro-Mechanics Co., Ltd., Gyunggi-do (KR)

(21) Appl. No.: 13/324,833

(22) Filed: Dec. 13, 2011

(30) Foreign Application Priority Data
Sep. 30, 2011 (KR) 1020110100189

(51) Int. Cl. H02K 21/38

(52) U.S. Cl. 310/49.46

(57) ABSTRACT

Disclosed herein is a switched reluctance motor including: a stator including a plurality of magnets and stator salient poles disposed between the plurality of magnets; and a rotor including salient poles formed at an inner diameter thereof so as to face the stator salient poles, wherein three stator salient poles are disposed between the magnets, the number of stator salient poles is 6*N and the number of salient poles of the rotor facing the stator salient poles is 3*N, where N indicates a natural number of 2 or more.

### CROSS REFERENCE TO RELATED ED APPLICATION

This application claims the benefit of Korean Patent Application No. 10-2011-0100189, filed on Sep. 30, 2011, entitled “Switched Reluctance Motor”, which is hereby incorporated by reference in its entirety into this application.

### BACKGROUND OF THE INVENTION

1. Technical Field

The present invention relates to a switched reluctance motor.

2. Description of the Related Art

Due to a recent rapid increase in cost of a rare earth magnet component that has been mainly used in order to reduce weight of a motor, the use of inexpensive magnets that does not contain a rare earth material has increased.

The motor according to the prior art has a three-phase structure, more specifically, a structure in which each of magnets is inserted into stator salient pole parts and a rotor may be configured in a three-phase.

In the case of this structure, many magnets are used, such that a motor torque is high.

However, a coil should be wound around a magnet insertion part and a core is separated from the magnet or is vulnerable to separation even though it is formed integrally with the magnet, such that it difficult to manufacture the motor.

### SUMMARY OF THE INVENTION

The present invention has been made in an effort to provide a switched reluctance motor capable of adjusting magnetic flux density and maximizing magnetic flux utilization efficiency.

According to a first preferred embodiment of the present invention, there is provided a switched reluctance motor including: a stator including a plurality of magnets and stator salient poles disposed between the plurality of magnets; and a rotor including salient poles formed at an inner diameter thereof so as to face the stator salient poles, wherein three stator salient poles are disposed to between the magnets, the number of stator salient poles is 6*N and the number of salient poles of the rotor facing the stator salient poles is 3*N, where N indicates a natural number of 2 or more.

The stator salient poles may be disposed at equidistance, and an interval between the stator salient poles may be smaller than an interval between the stator salient pole and the magnet.

The magnet may be a ferrite magnet or a magnet having magnetic force larger than that of the ferrite magnet, and the stator salient pole may have a coil wound therearound.

The magnets may be disposed at intervals corresponding to 360/the number of magnets in a radial direction of the stator.

The magnet may be extended in a direction toward an inner side of the stator so as to face the rotor.

The magnet may be extended in a direction toward an outer side of the stator.

The magnet may be extended in a direction toward inner and outer sides of the stator.

According to a second preferred embodiment of the present invention, there is provided a switched reluctance motor including: a stator including magnets and stator salient poles disposed between magnets; and a rotor including salient poles formed at an inner diameter thereof so as to face the stator salient poles, wherein three stator salient poles are disposed between the magnets, the number of stator salient poles is 6*N and the number of salient poles of the rotor corresponding to the stator salient poles is 5*N, where N indicates a natural number of 2 or more.

The stator salient poles may be disposed at equidistance, and an interval between the stator salient poles may be smaller than an interval between the stator salient pole and the magnet.

The magnet may be a ferrite magnet or a magnet having magnetic force larger than that of the ferrite magnet, and the stator salient pole may have a coil wound therearound.

The magnets may be disposed at intervals corresponding to 360/the number of magnets in a radial direction of the stator.

The magnet may be extended in a direction toward an inner side of the stator so as to face the rotor.

The magnet may be extended in a direction toward an outer side of the stator.

The magnet may be extended in a direction toward inner and outer sides of the stator.

### BRIEF DESCRIPTION OF THE DRAWINGS

FIG. 1 is a view showing a structure of three-phase 12/6 poles of a switched reluctance motor according to a preferred embodiment of the present invention; FIG. 2 is a view showing a structure of three-phase 12/10 poles of the switched reluctance motor according to the preferred embodiment of the present invention;

FIG. 3 is a view showing a basic structure in which magnets of the switched reluctance motor according to the preferred embodiment of the present invention are disposed at a central portion;

FIG. 4 is a view showing a structure in which magnets of the switched reluctance motor according to the preferred embodiment of the present invention are additional disposed at an outer side;

FIG. 5 is a view showing a structure in which magnets of the switched reluctance motor according to the preferred embodiment of the present invention are additional disposed at an inner side; and

FIG. 6 is a view showing a structure in which magnets of the switched reluctance motor according to the preferred embodiment of the present invention are additional disposed at inner and outer sides.

### DESCRIPTION OF THE PREFERRED EMBODIMENTS

Various objects, advantages and features of the invention will become apparent from the following description of embodiments with reference to the accompanying drawings. The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention. The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

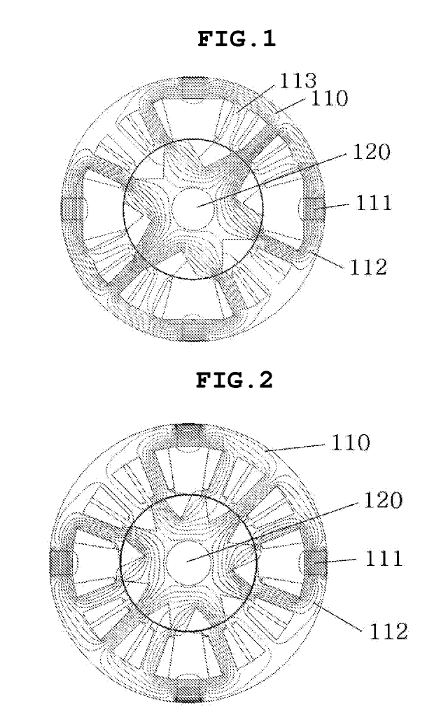

FIG. 1 is a view showing a structure of three-phase 12/6 poles of a switched reluctance motor according to a preferred embodiment of the present invention; and FIG. 2 is a view showing a structure of three-phase 12/10 poles of the switched reluctance motor according to the preferred embodiment of the present invention.

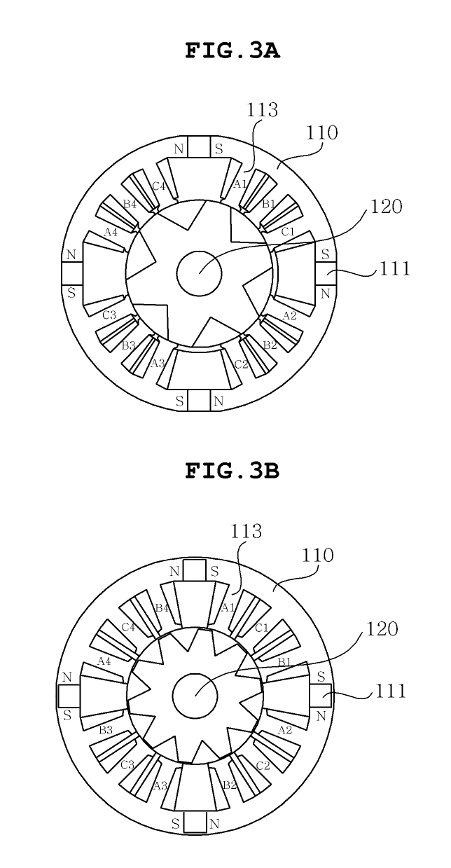

FIG. 3 is a view showing a basic structure in which magnets of the switched reluctance motor according to the preferred embodiment of the present invention are disposed at a central portion.

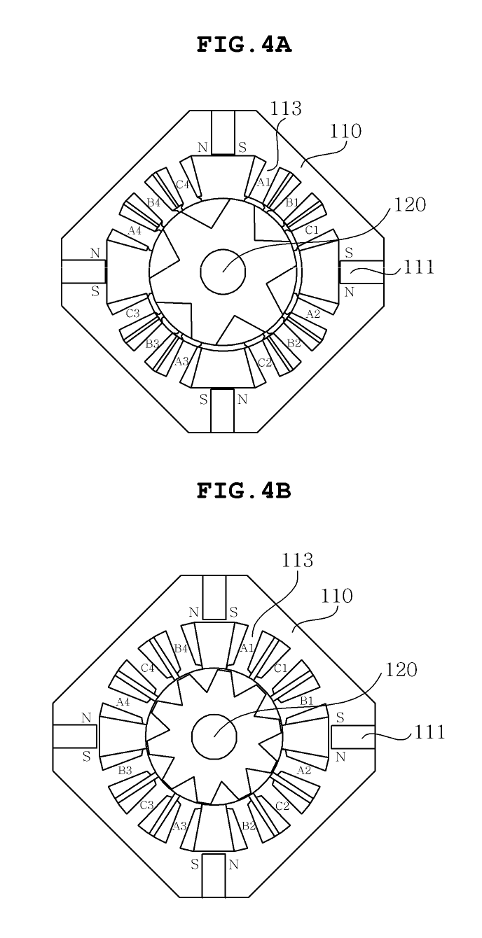

FIG. 4 is a view showing a structure in which magnets of the switched reluctance motor according to the preferred embodiment of the present invention are additional disposed at an outer side.

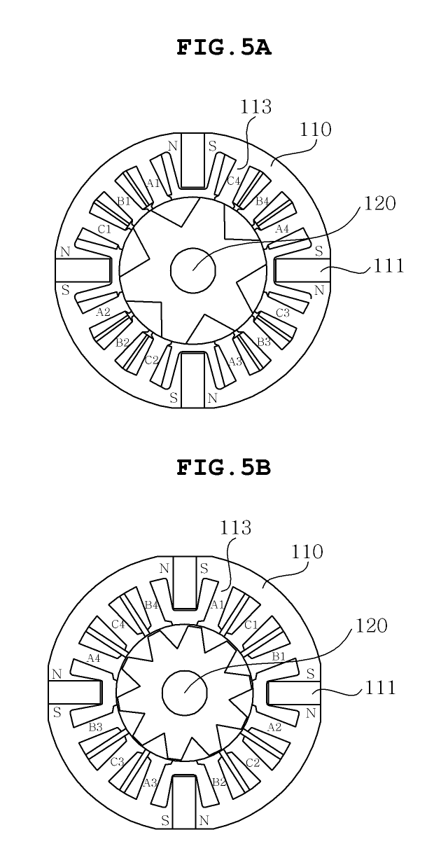

FIG. 5 is a view showing a structure in which magnets of the switched reluctance motor according to the preferred embodiment of the present invention are additional disposed at an inner side.

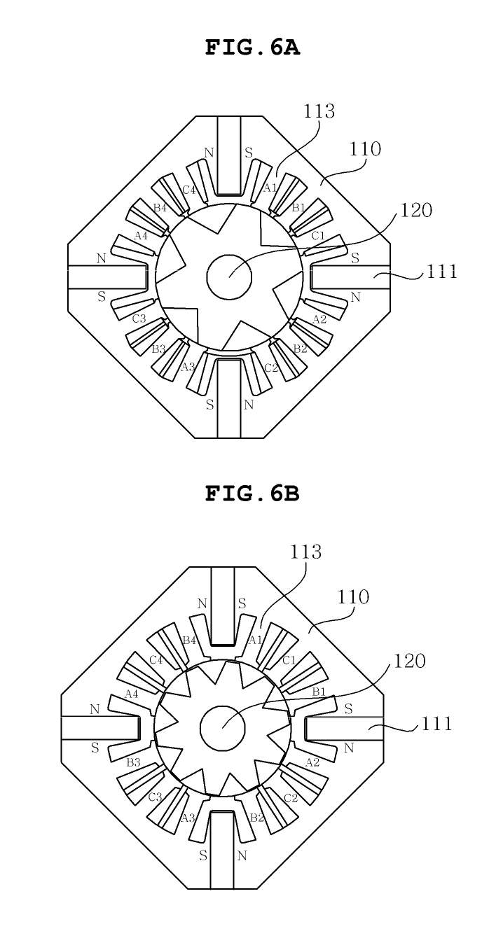

FIG. 6 is a view showing a structure in which magnets of the switched reluctance motor according to the preferred embodiment of the present invention are additional disposed at inner and outer sides.

The switched reluctance motor (SRM) according to the preferred embodiment of the present invention has a simple structure, such that it may be easily manufactured. In addition, the switched reluctance motor has robust characteristics since a rotor part thereof includes only a core without a magnet or a conductor (Al and Cu). Further, a magnet part is mounted in a stator, such that it may be easily cooled.

In addition, even though the switched reluctance motor according to the preferred embodiment of the present invention uses an inexpensive magnet (for example, a ferrite magnet, or the like) that does not contain a rare earth material, the switched reluctance motor has excellent torque characteristics and may detect counter electromotive force. Therefore, an existing three-phase brushless DC electric motor (BLDC) sensorless driving scheme may be applied to the switched reluctance motor according to the preferred embodiment of the present invention.

FIG. 1 is a view showing a structure of three-phase 12/6 poles of a switched reluctance motor according to a preferred embodiment of the present invention.

The switched reluctance motor according to the preferred embodiment of the present invention has a structure in which a separate magnet insertion part is formed in a core part, salient poles (three-phase) having the number corresponding to a multiple of 3 are formed between magnets, and coils are wound only around a salient pole part rather than a magnet part. This structure is simpler than that of an existing motor, such that the switched reluctance motor according to the preferred embodiment of the present invention may be easily manufactured.

In addition, since the magnet part does not include a separate coil, a length of the magnet may be vertically adjusted, a degree of freedom in selecting a kind of magnet according to motor characteristics is high, magnetic flux density may be adjusted, and the number of rotor poles may be reduced as compared to the existing motor, such that iron loss may be reduced.

As shown in FIG. 1, the switched reluctance motor according to the preferred embodiment of the present invention has a three-phase structure and includes a stator 110 having magnets 111 mounted therein and a rotor 120 mounted in an inner diameter of the stator 110.

The magnet 111 mounted in the stator 110 is a general ceramic magnet (for example, a ferrite magnet) rather than a rare earth magnet, such that magnetic flux utilization efficiency may be maximized and a structure of the switched reluctance motor may be simplified. As a result, the switched reluctance motor may be easily manufactured. In addition, a torque ripple may be minimized through three-phase driving.

As shown in FIGS. 1 and 2, the stator 110 of the switched reluctance motor according to the preferred embodiment of the present invention includes the magnets 111 and the coils 112 disposed therein. Here, the magnet part and the coil part are disposed independent of each other.

FIG. 1 is a view showing a structure in which a ratio of the number of salient poles of the stator 110 of the switched reluctance motor according to the preferred embodiment of the present invention to the number of salient poles of the rotor 120 thereof is 12/6; and FIG. 2 is a view showing a structure in which a ratio of the number of salient poles of the stator 110 of the switched reluctance motor according to the preferred embodiment of the present invention to the number of salient poles of the rotor 120 thereof is 12/10.

Three stator salient poles 113 are disposed between the magnets 111 and need to have an electrical phase difference of 120 degrees or 240 degrees as an electrical angle according to polarity of the rotor.

Only in this case, a three-phase combination, that is, a combination of A, B, and C that have a phase difference of 120 degrees or a combination of A, C, and B that have a phase difference of 240 degrees, is possible.

A portion at which the magnet 111 is disposed needs to have a phase difference of 180 degrees or 360 degrees as an electrical angle with respect to neighboring phases. In addition, since the magnet 111 has a pair of N and S poles, the stator needs to have the number of salient poles corresponding to 6*N (N indicates a natural number of two or more) in order to be implemented as a three-phase.

The structure of the switched reluctance motor according to the preferred embodiment of the present invention is different from an existing structure (FSPM or DSPM) in that the magnet part are independently disposed without a separate coil wound therearound, such that the number of poles is reduced as compared to the existing structures, thereby making it possible to reduce switching loss and to freely change a length of the magnet within a predetermined space according to the strength of the magnet.

That is, when a rare earth magnet (NdFeb or SmCO) having strong strength is used, a width of the magnet is narrowed, and when a ferrite magnet having weak strength is used, a width of the magnet is widened, thereby making it possible to freely adjust magnetic flux density in a range in which an iron core is not saturated.

Here, a combination of the stator 110 and the rotor 120 is most important. When a ratio of the number of salient poles of the stator 110 to the number of salient poles of the rotor 120 is 6*N/(3 or 5)*N (N indicates natural number of two or more), motor characteristics may be maximized.

That is, when the ratio of the number of salient poles of the stator 110 to the number of salient poles of the rotor 120 is 6*N/(3 or 5)*N (N indicates natural number of two or more) such as 12/6 or 12/10, or 18/9 or 18/15, or 24/12 or 24/20, the switched reluctance motor has most excellent characteristics.

This structure has a feature in that since the magnets 111 are disposed in the stator 110 and are thus easily cooled, thermally more robust characteristics are provided as compared to the case in which the magnets are disposed in the rotor 120.

In addition, since the rotor 120 has a structure similar to that of a rotor in an SRM motor and includes only a core, an air gap is reduced as compared to an existing case in which the magnets are disposed in the rotor, such that magnetic flux utilization efficiency may be maximized and the rotor 120 may have a robust structure.

Additionally, the stator salient poles 113 are disposed at an equidistance, which is smaller than an interval between the stator salient pole 113 and the magnet 111, and include the coil wound therearound.

FIGS. 3 to 6 are view showing examples in which a ratio of the number of salient poles of the stator 110 of the switched reluctance motor according to the preferred embodiment of the present invention to the number of salient poles of the rotor 120 thereof is expanded.

FIG. 3 is a view showing a basic structure for a ratio of the number of salient poles of the stator 110 of the switched reluctance motor according to the preferred embodiment of the present invention to the number of salient poles of the rotor 120 thereof; in which the magnets 111 are disposed at a central portion between a pair of stator salient poles 113 (A, B, and C) and another pair of stator salient poles 113.

Four pairs of stator salient poles 113 of A, B, and C are formed, and four magnets 111 are also formed between the stator salient poles 113.

FIG. 3A is a view showing a case in which a ratio of the number of salient poles of the stator 110 of the switched reluctance motor according to the preferred embodiment of the present invention to the number of salient poles of the rotor 120 thereof is 12/6; and FIG. 3B is a view showing a case in which a ratio of the number of salient poles of the stator 110 of the switched reluctance motor according to the preferred embodiment of the present invention to the number of salient poles of the rotor 120 thereof is 12/10.

FIG. 4 is a view showing a structure in which the magnet 111 of the stator 110 of the switched reluctance motor according to the preferred embodiment of the present invention are additionally disposed at an outer side, in which the magnets 111 are disposed at a central portion between a pair of stator salient poles 113 (A, B, and C) and another pair of stator salient poles 113.

The magnets 111 of FIG. 4 has a structure in which the magnets 111 shown in FIG. 3 are additionally disposed at the outer side and has a shape in which a length thereof is extended outwardly.

As described above, the magnets 111 may be additionally disposed at the outer side or the inner side according to applications of the motor and magnetic strength of the magnet.

Four pairs of stator salient poles 113 of A, B, and C are formed, and four magnets 111 are also formed between the stator salient poles 113.

FIG. 4A is a view showing a case in which a ratio of the number of salient poles of the stator 110 of the switched reluctance motor according to the preferred embodiment of the present invention to the number of salient poles of the rotor 120 thereof is 12/6; and FIG. 4B is a view showing a case in which a ratio of the number of salient poles of the stator 110 of the switched reluctance motor according to the preferred embodiment of the present invention to the number of salient poles of the rotor 120 thereof is 12/10.

FIG. 5 is a view showing a structure in which the magnet 111 of the stator 110 of the switched reluctance motor according to the preferred embodiment of the present invention are additionally disposed at the inner side, in which the magnets 111 are disposed at a central portion between a pair of stator salient poles 113 (A, B, and C) and another pair of stator salient poles 113.

The magnets 111 of FIG. 5 has a structure in which the magnets 111 shown in FIG. 3 are additionally disposed at the inner side and has a shape in which a length thereof is extended inwardly.

As described above, the magnets 111 may be additionally disposed at the outer side or the inner side according to applications of the motor and magnetic strength of the magnet.

Four pairs of stator salient poles 113 of A, B, and C are formed, and four magnets 111 are also formed between the stator salient poles 113.

FIG. 5A is a view showing a case in which a ratio of the number of salient poles of the stator 110 of the switched reluctance motor according to the preferred embodiment of the present invention to the number of salient poles of the rotor 120 thereof is 12/6; and FIG. 5B is a view showing a case in which a ratio of the number of salient poles of the stator 110 of the switched reluctance motor according to the preferred embodiment of the present invention to the number of salient poles of the rotor 120 thereof is 12/10.

FIG. 6 is a view showing a structure in which the magnet 111 of the stator 110 of the switched reluctance motor according to the preferred embodiment of the present invention are additionally disposed at the inner and outer sides, in which the magnets 111 are disposed at a central portion between a pair of stator salient poles 113 (A, B, and C) and another pair of stator salient poles 113.

The magnets 111 of FIG. 6 has a structure in which the magnets 111 shown in FIG. 3 are additionally disposed at the inner and outer sides and has a shape in which a length thereof is extended inwardly and outwardly.

As described above, the magnets 111 may be additionally disposed at the inner and outer sides according to applications of the motor and magnetic strength of the magnet.

Four pairs of stator salient poles of A, B, and C are formed, and four magnets are also formed between the stator salient poles 113.

FIG. 6A is a view showing a case in which a ratio of the number of salient poles of the stator 110 of the switched reluctance motor according to the preferred embodiment of the present invention to the number of salient poles of the rotor 120 thereof is 12/6; and FIG. 6B is a view showing a case in which a ratio of the number of salient poles of the stator 110 of the switched reluctance motor according to the preferred embodiment of the present invention to the number of salient poles of the rotor 120 thereof is 12/10.

In the switched reluctance motor according to the preferred embodiment of the present invention having the above-mentioned configuration, the rotor 120 is provided in the inner diameter of the stator 110, the magnets 111 are disposed only in the stator 110, and the magnets 111 having different polarities face each other.

In addition, the rotor 120 includes only a salient pole type core, and each of the magnet 111 and the coil 112 winding is disposed independent of each other. The switched reluctance motor according to the preferred embodiment of the present invention is a three-phase driving apparatus in which three stator salient poles 113 are present between the magnets 111.

Here, the number of salient poles of the stator 110 is 6*N (N: 2, 3 . . . ) (for example, 12/6, 18/9, . . . ), and the number of salient poles of the rotor 120 corresponding thereto is 3*N or 5*N (for example, 12/10, 18/15, . . . ).

In addition, a length of the magnet is in a range in which the iron core of the stator core is not saturated and may be vertically adjusted according to a material of the magnet and a structure of the motor.

The core part of the rotor may be stacked at a predetermined angle or be stacked as several stages in an axial direction and be assembled at a predetermined angle at the time of assembly, in order to improve characteristics such as a reduction in cogging torque.

Furthermore, the stator 110 includes an outer stator and inner stator and the rotor 120 also includes an outer rotor and an inner rotor.

As described above, the switched reluctance motor (hereinafter, referred to as SRM) according to the preferred embodiment of the present invention has a simple structure, such that it may be easily manufactured. In addition, the switched reluctance motor has robust characteristics since a rotor part thereof includes only a core without a magnet or a conductor (Al and Cu). Further, a magnet part is mounted in a stator, such that it may be easily cooled.

In addition, even though the switched reluctance motor according to the preferred embodiment of the present invention uses an inexpensive magnet (for example, a ferrite magnet, or the like) that does not contain a rare earth material, the switched reluctance motor has excellent torque characteristics and may detect counter electromotive force. Therefore, an existing three-phase brushless DC electric motor (BLDC) sensorless driving scheme may be applied to the switched reluctance motor according to the preferred embodiment of the present invention.

Furthermore, various modifications of a structure may be made. For example, the magnets 111 may be additionally disposed at the inner and outer sides according to applications of the motor and magnetic strength of the magnet.

The switched reluctance motor (SRM) according to the preferred embodiment of the present invention has a simple structure, such that it may be easily manufactured. In addition, the switched reluctance motor has robust characteristics since a rotor part thereof includes only a core without a magnet or a conductor (Al and Cu). Further, a magnet part is mounted in a stator, such that it may be easily cooled.

In addition, even though the switched reluctance motor according to the preferred embodiment of the present invention uses an inexpensive magnet (for example, a ferrite magnet, or the like) that does not contain a rare earth material, the switched reluctance motor has excellent torque characteristics and may detect counter electromotive force. Therefore, an existing three-phase brushless DC electric motor (BLDC) sensorless driving scheme may be applied to the switched reluctance motor according to the preferred embodiment of the present invention.

That is, when a rare earth magnet (NdFeb or SmCO) having strong strength is used, a width of the magnet is narrowed, and when a ferrite magnet having weak strength is used, a width of the magnet is widened, thereby making it possible to freely adjust magnetic flux density in a range in which an iron core is not saturated.

Here, a combination of the stator 110 and the rotor 120 is most important. When a ratio of the number of salient poles of the stator 110 to the number of salient poles of the rotor 120 is 6*N/(3 or 5)*N (N indicates natural number of two or more), motor characteristics may be maximized.

That is, when the ratio of the number of salient poles of the stator to the number of salient poles of the rotor is 6*N/(3 or 5)*N such as 12/6 or 12/10, or 18/9 or 18/15, or 24/12 or 24/20, the switched reluctance motor has most excellent characteristics.

This structure has a feature in that since the magnets are disposed in the stator and are thus to easily cooled, thermally more robust characteristics are provided as compared to the case in which the magnets are disposed in the rotor.

In addition, since the rotor 120 has a structure similar to that of a rotor in an SRM motor and includes only a core, an air gap is reduced as compared to an existing case in which the magnets are disposed in the rotor, such that magnetic flux utilization efficiency may be maximized and the rotor 120 may have a robust structure.

Although the preferred embodiments of the present invention have been disclosed for illustrative purposes, they are for specifically explaining the present invention and thus a switched reluctance motor according to the present invention is not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A switched reluctance motor comprising:
a stator including a plurality of magnets and stator salient poles disposed between the plurality of magnets; and
a rotor including salient poles formed at an inner diameter thereof so as to face the stator salient poles,
wherein three stator salient poles are disposed between the magnets, the number of stator salient poles is 6*N and the number of salient poles of the rotor facing the stator salient poles is 3*N, where N indicates a natural number of 2 or more.

2. The switched reluctance motor as set forth in claim 1, wherein the stator salient poles are disposed at equidistance, and an interval between the stator salient poles is smaller than an interval between the stator salient pole and the magnet.

3. The switched reluctance motor as set forth in claim 1, wherein the magnet is a ferrite magnet or a magnet having magnetic force larger than that of the ferrite magnet, and the stator salient pole has a coil wound therearound.

4. The switched reluctance motor as set forth in claim 1, wherein the magnets are disposed at intervals corresponding to 360/the number of magnets in a radial direction of the stator.

5. The switched reluctance motor as set forth in claim 1, wherein the magnet is extended in a direction toward an inner side of the stator so as to face the rotor.

6. The switched reluctance motor as set forth in claim 1, wherein the magnet is extended in a direction toward an outer side of the stator.

7. The switched reluctance motor as set forth in claim 1, wherein the magnet is extended in a direction toward inner and outer sides of the stator.

8. A switched reluctance motor comprising:
a stator including magnets and stator salient poles disposed between magnets; and
a rotor including salient poles formed at an inner diameter thereof so as to face the stator salient poles,
wherein three stator salient poles are disposed between the magnets, the number of stator salient poles is 6*N and the number of salient poles of the rotor corresponding to the stator salient poles is 5*N, where N indicates a natural number of 2 or more.

9. The switched reluctance motor as set forth in claim 8, wherein the stator salient poles are disposed at equidistance, and an interval between the stator salient poles is smaller than an interval between the stator salient pole and the magnet.

10. The switched reluctance motor as set forth in claim 8, wherein the magnet is a ferrite magnet or a magnet having magnetic force larger than that of the ferrite magnet, and the stator salient pole has a coil wound therearound.

11. The switched reluctance motor as set forth in claim 8, wherein the magnets are disposed at intervals corresponding to 360/the number of magnets in a radial direction of the stator.

12. The switched reluctance motor as set forth in claim 8, wherein the magnet is extended in a direction toward an inner side of the stator so as to face the rotor.

13. The switched reluctance motor as set forth in claim 8, wherein the magnet is extended in a direction toward an outer side of the stator.

14. The switched reluctance motor as set forth in claim 8, wherein the magnet is extended in a direction toward inner and outer sides of the stator.
